(19) United States
(12) Patent Application Publication
(10) Pub. No.: US 2012/0143864 A1
(43) Pub. Date: Jun. 7, 2012

(54) Method and Apparatus for Generating and Managing Service Requests

(75) Inventors: Kevin Michael Quigley, West Sussex (GB); Mark Izatt, London (GB); Leo James, Hook (GB)

(73) Assignee: NOKIA CORPORATION, Espoo (FI)

(21) Appl. No.: 12/961,434

(22) Filed: Dec. 6, 2010

(51) Int. Cl. G06F 17/30

(52) U.S. Cl. 707/736; 707/E17.044

(57) ABSTRACT

An example approach is provided for generating and managing service requests. One or more service requests are generated. Further, the one or more requests are assigned to one or more service providers and are aggregated. Furthermore, one or more updates are presented on at least a portion of the aggregation.

### BACKGROUND

Service providers (e.g., wireless and cellular services) and device manufacturers are continually challenged to deliver value and convenience to consumers by, for example, providing compelling network services and advancing the underlying technologies. One area of interest has been the development of services and technologies where users/consumers could request different services from service providers. However, as the users may be busy with other tasks and may not have time to contact the service providers for updates on their requests, still, the users need to track the progress of the requests. Accordingly, service providers and device manufacturers face significant technical challenges to enabling the generation and management of service requests.

### SOME EXAMPLE EMBODIMENTS

Therefore, there is a need for an approach for generating and managing service requests.

According to one embodiment, a method comprises determining at least one record of at least one transaction between a user and at least one service provider. The method also comprises determining an aggregation of the at least one record with one or more other records, the one or more other records relating to one or more other transactions between the user and the at least one service provider, one or more other service providers, or a combination thereof. The method additionally comprises determining to cause, at least in part, one or more actions that result in presentation of at least a portion of the aggregation at one or more devices associated with the user.

According to another embodiment, an apparatus comprises at least one processor, and at least one memory including computer program code for one or more programs, the at least one memory and the computer program code configured to, with the at least one processor, cause the apparatus, at least in part, to process at least one record of at least one transaction between a user and at least one service provider. The apparatus additionally is caused, at least in part, to process at least one aggregation of the at least one record with one or more other records, the one or more other records relating to one or more other transactions between the user and the at least one service provider, one or more other service providers, or a combination thereof. The apparatus is further caused, at least in part, to determine to cause, at least in part, one or more actions for resulting in presentation of at least a portion of the aggregation at one or more devices associated with the user.

According to another embodiment, a computer-readable storage medium carrying one or more sequences of one or more instructions which, when executed by one or more processors, cause an apparatus, at least in part, to process at least one record of at least one transaction between a user and at least one service provider. The apparatus additionally is caused, at least in part, to process at least one aggregation of the at least one record with one or more other records, the one or more other records relating to one or more other transactions between the user and the at least one service provider, one or more other service providers, or a combination thereof. The apparatus is further caused, at least in part, to determine to cause, at least in part, one or more actions for resulting in presentation of at least a portion of the aggregation at one or more devices associated with the user.

According to another embodiment, an apparatus comprises means for determining at least one record of at least one transaction between a user and at least one service provider. The apparatus also comprises means for causing, at least in part, determining an aggregation of the at least one record with one or more other records, the one or more other records relating to one or more other transactions between the user and the at least one service provider, one or more other service providers, or a combination thereof. The apparatus further comprises means for causing, at least in part, determining to cause, at least in part, and one or more actions that result in presentation of at least a portion of the aggregation at one or more devices associated with the user.

A method comprising facilitating a processing of and/or processing: (1) data and/or (2) information and/or (3) at least one signal; the (1) data and/or (2) information and/or (3) at least one signal based at least in part on at least one record of at least one transaction between a user and at least one service provider. The method also comprises at least one aggregation of the at least one record with one or more other records, the one or more other records relating to one or more other transactions between the user and the at least one service provider, one or more other service providers, or a combination thereof. The method further comprises at least one determination to cause, at least in part, one or more actions for resulting in presentation of at least a portion of the aggregation at one or more devices associated with the user.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating and managing service requests, according to an embodiment;

FIG. 2 is a diagram of the components of a service aggregator, according to an embodiment;

FIG. 3 is a diagram of the components of user equipment, according to an embodiment;

FIG. 4 is a flowchart of a process for receiving and managing service requests, according to an embodiment;

FIG. 5 is a flowchart of a process for providing status information on service requests, according to an embodiment;

FIG. 6 is a flowchart of a process for generating service requests, according to an embodiment;

FIG. 7 is a time sequence diagram that illustrates a sequence of messages and processes for generating and managing service requests, according to an embodiment;

FIGS. 8A-8C are diagrams of user interfaces utilized in the processes of FIGS. 4-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of exemplary components of a mobile terminal (e.g., handset) for communications, which is capable of operating in the system of FIG. 1, according to one embodiment.

### DESCRIPTION OF SOME EMBODIMENTS

Examples of a method, apparatus, and computer program for generating and managing service requests are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

User services, such as concierge services, are available to assist users with many different tasks, such as arranging for travel, lodging, dining and/or other accommodations. These user services can be available based on user location, service area location, user device location and the like. Generally, concierge services are available at an establishment (e.g., a hotel) or via a service provider (e.g., a services vendor company, a communications provider company, etc.), which can be available to certain groups of users (e.g., users of certain services/devices, guests at a certain establishment, residents of a community, etc.) and/or can be available to any user who wishes to receive the service (e.g., for a fee or free). Further, the users may request for the services via different communication means, for example, via phone, internet, in person, etc., with one or more dedicated service providers (e.g., a user may be assigned to a service provider at the time of creation of user account) such that the user can often receive personal service from the same one or more service providers. Furthermore, the user can request for one or more services from one or more service providers (e.g., a concierge service) where the service provider arranges for delivery of the one or more services. Additionally, the user may require status updates on the one or more service requests, but may not have time to continuously enquire about such status updates from the service provider. Alternatively, the service provider may need to obtain additional information from the user, which can be done while providing status update on the one or more service requests. In order to track and update the status of the one or more service requests, a service aggregator can be utilized so that the user and the service provider can achieve the desired effects. In an example system, the status update on the one or more service requests are aggregated via a service aggregator whereby the updated information can be provided and/or obtained substantially automatically via one or more communications means (e.g., phone, internet, SMS, MMS, etc.).

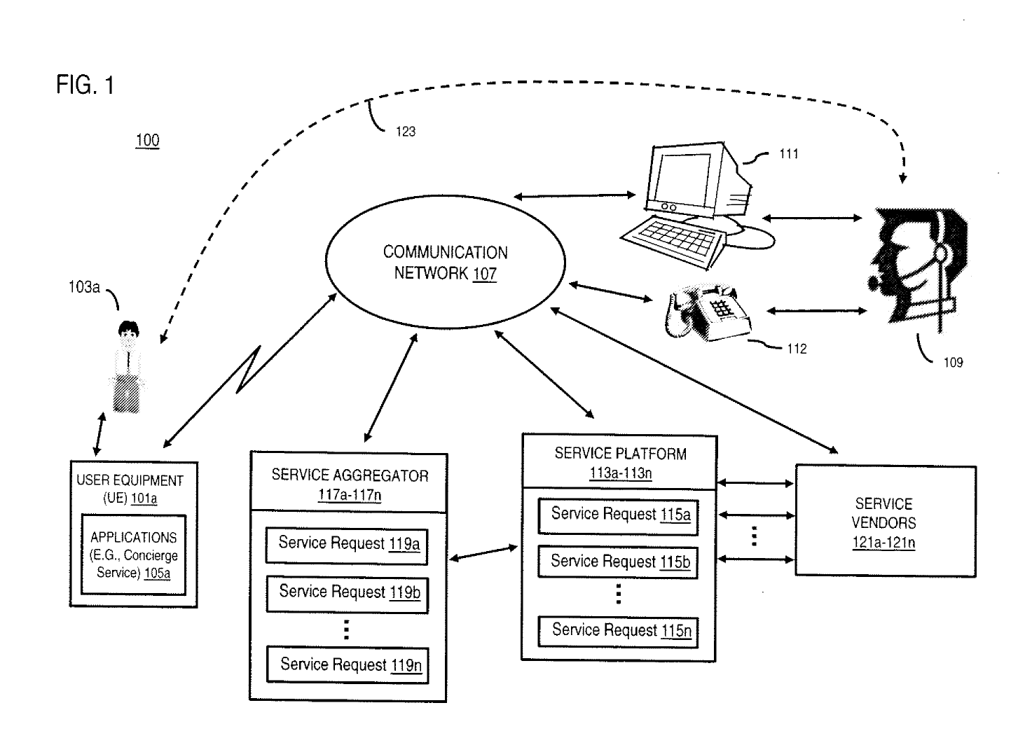

FIG. 1 is a diagram of system 100 capable of generating and managing service requests, according to an embodiment. As noted above, a user can generate one or more service requests to one or more service providers and/or one or more service platforms. Further, the service provider and/or the service platform arrange for delivery of the one or more services by one or more service vendors. Furthermore, the one or more service requests are aggregated by a service aggregator whereby further status updates on the one or more service requests are provided. In one scenario, the service platform provides status updates on the one or more completed and/or pending service requests. In another scenario, the user and/or the user device can provide status updates on the one or more completed and/or pending service requests.

In one embodiment, the user generates a service request and based on the user location, the service request is routed to a corresponding service platform which can provide service to the request. In another embodiment, the service request is routed to a service provider based on one or more criteria such as geographical location, language required by the user, device type, service request type, and the like.

In another embodiment, the service platform requests further information from the user on the one or more user service requests. For example, the service provider may need user feedback on an alternate service, required time of service and the like.

In another embodiment, the user can modify one or more existing requests, for example, change the one or more criteria (e.g., time of service, type of accommodation, location of service, etc.).

In another embodiment, the user can contact the service provider by utilizing one or more different user devices and/or one or more different communication methods, for example, a phone, a computer, a website, in person and/or the like.

System 100 of FIG. 1 introduces the capability of generating and managing one or more service requests. In one embodiment, a user 103a utilizes user equipment (UEs) 101a-101n (also collectively known as UEs 101), which may be utilized to generate one or more service requests to one or more service providers 109 (e.g., a concierge service agent) over a communication network 107 and/or via a communication link 123. Further, the service provider 109 may communicate via 111 (e.g., a computer) and/or 112 (e.g., a phone) and utilize one or more service platforms 113a-113n (also collectively known as service platform 113) over a communication network 107 to submit one or more service requests 115a-115n (also collectively known as service request 115). In certain embodiments, service platform 113 (e.g., a computing device) may be utilized to manage the service requests 115, coordinate and facilitate communications between UEs 101 and/or service vendors 121a-121n (also collectively known as service vendors 121) for requesting and/or acquiring the one or more services (e.g., transportation, hotel, accommodations, etc). Users may execute one or more applications 105a-105n (also collectively known as applications 105) (e.g., a mapping application, a messaging application, a concierge service application, etc.) on the UEs 101 to access the service aggregator 117 as well as other platforms such as service platform 113 that may be accessible via the communication network 107. The service platform 113 can provide one or more services (e.g., location based services, mapping information, travel related services, etc.) to one or more users by utilizing one or more service vendors 121. Further, in certain embodiments, the UEs 101 may be utilized to communicate, via the communication network 107, with service platform 113 to request and/or acquire service request status information. In other embodiments, other devices (e.g., a navigation device) may be utilized to request and/or acquire one or more services and/or service request status information. Although various embodiments are described with respect to service requests, it is contemplated that the example approach described herein may be used with other types of services and/or requests.

As noted above, in certain embodiments, the UE 101 includes applications 105, including one or more concierge service applications, which can communicate with the service aggregator 117. Although various embodiments are described with respect to the service aggregator 117, it is contemplated that the approaches described herein may be performed (or partially performed) by other applications (e.g., location based services, mapping, guest services, etc). The service aggregator 117 may be, in certain scenarios, a program that utilizes an application programming interface (API) to utilize one or more services of the service platform 113. The service aggregator 117 may further be a widget that can be installed and executed in a web page or a web runtime engine or a native program. Widgets are light-weight applications, and provide a convenient means for rendering information and accessing services. Moreover, the service aggregator 117 may be implemented, at least in part, as part of the service platform 113 and/or may be implemented, at least in part, on the UEs 101.

In another embodiment, service vendors 121 provide one or more services to the service platform 113 for fulfilling the one or more requests from the one or more users. In certain embodiments, the service vendors 121 can be part of the service platform 113 and/or can provide services in conjunction with one or more other service vendors 121.

In one embodiment, the service platform 113 may request additional information from the user 103 via the service aggregator 117 whereby the user can provide the additional information via the service aggregator 117.

It is noted that in various embodiments, the service provider 109 may be implemented, at least in part, as part of the service platform 113 or vice versa. Additionally, the service aggregator 117 can be implemented, at least in part, in the UEs 101 and/or in the service platform 113.

In an example use case, the user 103 contacts the service provider 109 (e.g., a concierge agent) and requests for transportation service. The service provider 109 creates a service request 115a, at least in part, via the service platform 113. Further, the service request 115a is transmitted to one or more service vendors 121 and to the service aggregator 117, where the service request is listed, for example, as service request 119a. Furthermore, the service agent 109 and/or the service platform 113 request and/or receive one or more updates from the one or more service vendors 121 indicating one or more information (e.g., transportation service availability time, driver name, vehicle info, etc.) related to the service request 115a. Moreover, the updated information may be requested by and/or transmitted to the service aggregator 117 as update information on service request 119a. Alternatively, the service agent 109 and/or the service platform 113 may request one or more information from the user regarding the service request 119a, for example, destination of the user, if an alternate vehicle would be acceptable, duration of time the transportation vehicle would be required by the user and the like.

By way of example, the communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, navigation device, entertainment system/device, information system/device or any combination thereof. It is also contemplated that the UE 101 can support any type of interface to the user (such as “wearable” circuitry, etc.).

By way of example, the UE 101, service aggregator 117, and service platform 113 communicate with each other and other components of the communication network 107 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

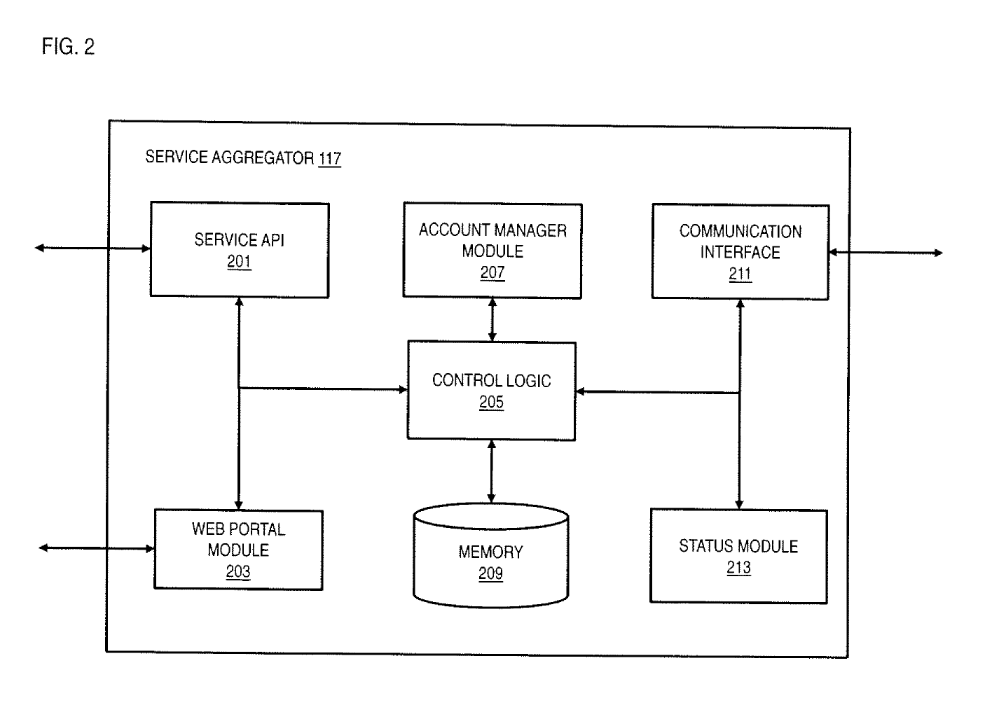

FIG. 2 is a diagram of the components of a service aggregator, according to an embodiment. By way of example, the service aggregator 117 includes one or more components for tracking and updating of one or more service requests. It is contemplated that the functions of these components may be combined in one or more components or performed by other components of equivalent functionality. In this embodiment, the service aggregator 117 includes a service API 201, a web portal module 203, control logic 205, an account manager module 207, memory 209, a communication interface 211, and a status module 213.

In one embodiment, the control logic 205 can be utilized in controlling the execution of modules and interfaces of the service aggregator 117. The program modules can be stored in the memory 209 while executing. A communication interface 211 can be utilized to interact with UEs 101 (e.g., via a communication network 107). Further, the control logic 205 may utilize the service API 201 (e.g., in conjunction with the communication interface 211) to interact with service platform 113 and/or other applications, platforms, and the like. In one embodiment, the API 201 provides an interface between the service aggregator 117 and the service platform 113 as one mechanism for communicating, for example, update information.

Furthermore, the communication interface 211 may include multiple means of communication. For example, the communication interface 211 may be able to communicate via SMS, MMS, internet protocol, instant messaging, voice sessions (e.g., via a phone network), or other types of communication methods. The UE 101 can send information to the service platform 113 for many reasons, such as to update the status of applications executing on the UE 101, update information on the one or more service requests, update user account information, etc. Further, the control logic module 205 may utilize the communication interface 211 to provide status updates to the UE 101. The communication interface 211 can be used by the control logic 205 to communicate with the UEs 101a-101n, and other devices. In some examples, the communication interface 211 is used to transmit and receive information using protocols and methods associated with the service API 201.

By way of example, the account manager module 207 may be utilized to handle users of the service platform as well as any data associated with the users. As such, the account manager module 207 may validate user logins, manage user information (e.g., name, date of birth, gender, device ID, device type, user schedule, social network group associations, etc.), generate notifications to send to the UEs 101 via the communication interface 211 and/or API 201, etc. Moreover, the account manager module 207 may coordinate with a web portal module 203 to facilitate access to the social service platform 103. Additionally, the web portal module 203 can generate a webpage and/or a web access API to allow UEs 101 to access the service platform 113. In addition, the status module 213 may be utilized to manage the service request, for example, request/receive status updates and/or submit information on or more service requests.

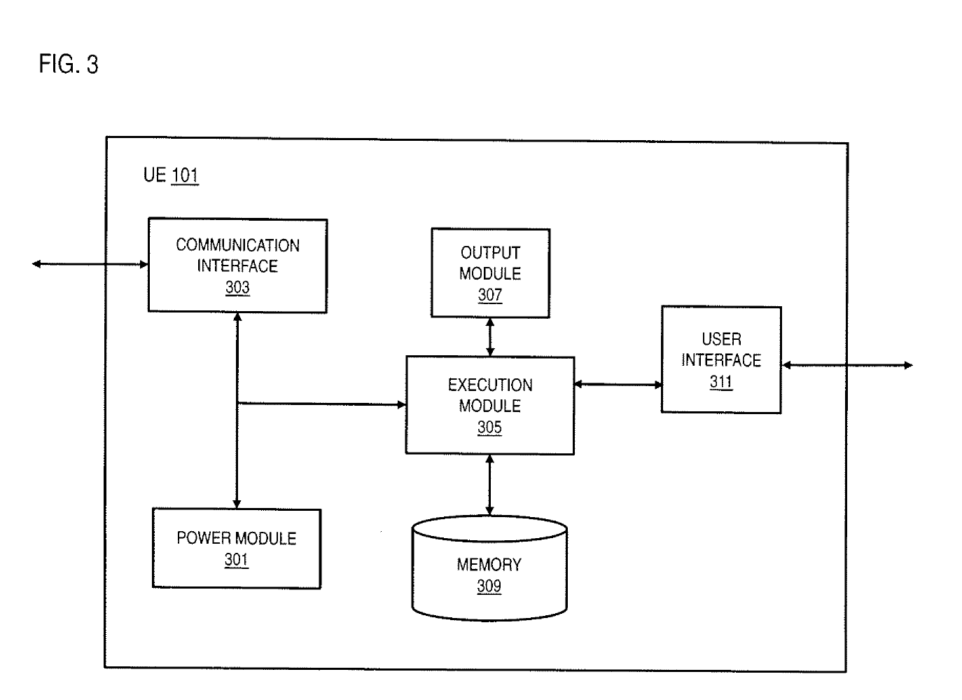

FIG. 3 is a diagram of the components of user equipment, according to an embodiment. It is contemplated that the functions of these components may be combined in one or more components or performed by other components of equivalent functionality. In this embodiment, the UE 101 includes a power module 301 to provide power and power controls to the UE 101, a communication interface 303 to communicate over a network, an execution module 305 to control the runtime of applications executing on the UE 101, an output module 307, a memory 309, a user interface 311 to output and receive input at the UE 101.

In one embodiment, the UE 101 includes a power module 301. The power module 301 provides power to the UE 101. The power module 301 can include any type of power source (e.g., battery, plug-in, etc.). Additionally, the power module 301 can provide power to the components of the UE 101 including processors, memory 309, and transmitters.

The communication interface 303 may include multiple means of communication. For example, the communication interface 303 may be able to communicate over SMS, internet protocol, instant messaging, voice sessions (e.g., via a phone network), or other types of communication. The communication interface 303 can be used by the execution module 305 to communicate with other UEs 101, the service aggregator 117, service platform 113 and other devices. In some examples, the communication interface 303 is used to transmit information (e.g., service request information, user status information, etc.) to the service platform 113, service aggregator 117 and the like.

In one embodiment, a UE 101 includes a user interface 311. The user interface 311 can include various methods of communication. For example, the user interface 311 can have outputs including a visual component (e.g., a screen), an audio component, a physical component (e.g., vibrations), and other methods of communication. User inputs can include a touch-screen interface, a scroll-and-click interface, a button interface, etc. In certain embodiments, the user interface 311 may additionally have a vocal user interface component. As such, a text-to-speech mechanism may be utilized to provide textual information to the user. Further, a speech-to-text mechanism may be utilized to receive vocal input and convert the vocal input into textual input. Moreover, the user interface 311 may be utilized to present status information as to the status of one or more service requests.

In certain embodiments, the service aggregator 117 may run on the execution module 305. The service aggregator application 117 may utilize the user interface 311 to receive information regarding one or more service requests and/or acquisition of the one or more service requests. Further, this information may be transmitted via the communication interface 303 to the service aggregator 117 and/or service platform 113. Moreover, the information may be utilized by a service aggregator and/or service platform to alert the user about one or more services and/or one or more service requests. This information may be stored in the memory 309 until utilized. The service aggregator 117 then returns the status of one or more service results to the requesting UE 101 via the output module 307 and the service application programming interface (API) 201.

In one embodiment, the output module 307 facilitates a creation and/or a modification of at least one device user interface element, at least one device user interface functionality, or a combination thereof based, at least in part, on information, data, messages, and/or signals resulting from any of the processes and or functions of the service aggregator 117 and/or any of its components or modules. By way of example, a device user interface element can be a display window, a prompt, an icon, and/or any other discrete part of the user interface presented at, for instance, the UE 101. In addition, device user interface functionality refers to any process, action, task, routine, etc. that supports or is triggered by one or more of the user interface elements. For example, user interface functionality may enable speech to text recognition, haptic feedback, and the like. Moreover, it is contemplated that the output module 307 can operate based at least in part on processes, steps, functions, actions, etc. taken locally (e.g., local with respect to a UE 101) or remotely (e.g., over another component of the communication network 107 or other means of connectivity).

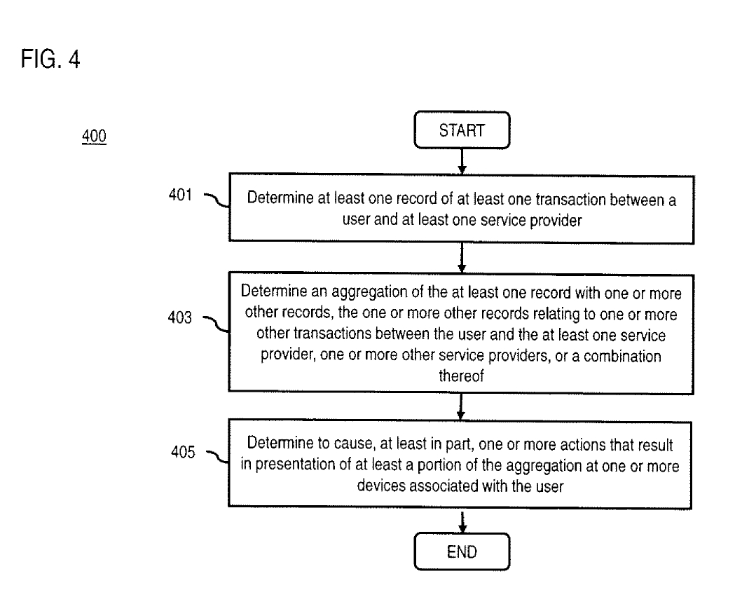

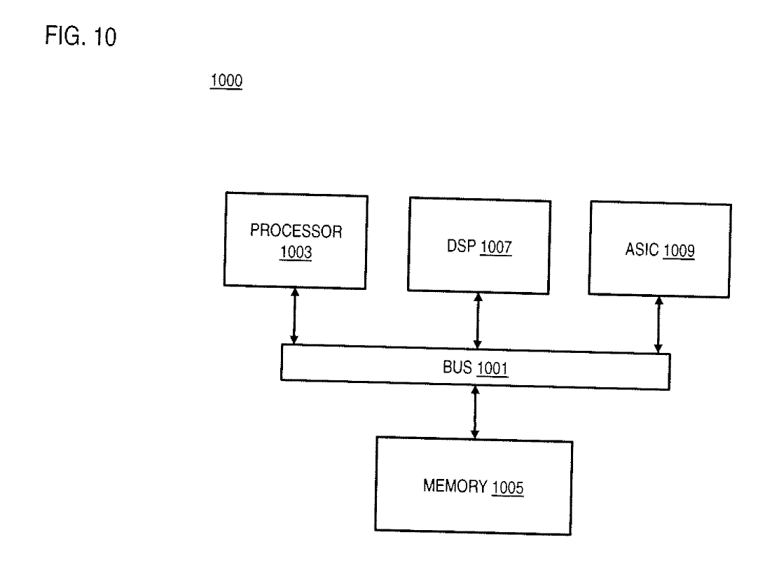

FIG. 4 is a flowchart of a process for receiving and managing service requests, according to an embodiment. In one embodiment, the control logic 205 of the service aggregator 117 performs the process 400 and is implemented in, for instance, a chip set including a processor and a memory as shown FIG. 10. In certain embodiments, the execution module 305 of a UE 101 may perform one or more steps of the process performed by the control logic 205. As such, the control logic 205 or execution module 305 can provide means for accomplishing various parts of the process 400 as well as means for accomplishing other processes in conjunction with other components. In step 401, the control logic 205 determines at least one record of at least one transaction between a user and at least one service provider. The transaction may be received at the control logic 205 via a communication interface 211. In certain embodiments, the transaction record is data that can be utilized to coordinate one or more service requests. As such, service request information may include information such as geographical location information (e.g., provided by a GPS system, a cellular network, etc.). Further, the service request may further include information associated with the type of service, time of service, user information, user device information, service provider information, and the like. In one embodiment, the UE 101 can employ a dedicated function key (e.g., a hardware key, a user interface key, a key implemented in software, a voice command, a touch pad key, a touch gesture, etc.) to activate and launch one or more service request sessions at the UE 101. In one embodiment, the user generates one or more service requests via, at least in part, the service provider 109 (e.g., a concierge agent) and/or the service platform 113.

At step 403, the control logic 205 causes, at least in part, determining an aggregation of the at least one record with one or more other records, the one or more other records relating to one or more other transactions between the user and the at least one service provider, one or more other service providers, or a combination thereof. In an embodiment, one or more records of service requests are presented to the user via, at least in part, the service aggregator 117. For example, the records can indicate one or more service requests for accommodations at a hotel, transportation from an airport to the hotel, reservations for dinner at a restaurant and/or the like.

Moreover, at step 405, the service aggregator 117 determines to cause, at least in part, one or more actions that result in presentation of at least a portion of the aggregation at one or more devices associated with the user. In one embodiment, the records can include one or more data, for example, time that the service request was generated, an estimated time that the service request will be completed, location of service provider, location of service vendor, and the like. For example a record can indicate: a service request is for transportation from an airport, the request was submitted to a local limousine service company, the limousine driver will meet the user at the baggage area, the driver's name is John Smith and he will be display a sign indicative of the user's name. Further, the one or more records can present information, for example, on the hotel accommodations arranged for the user.

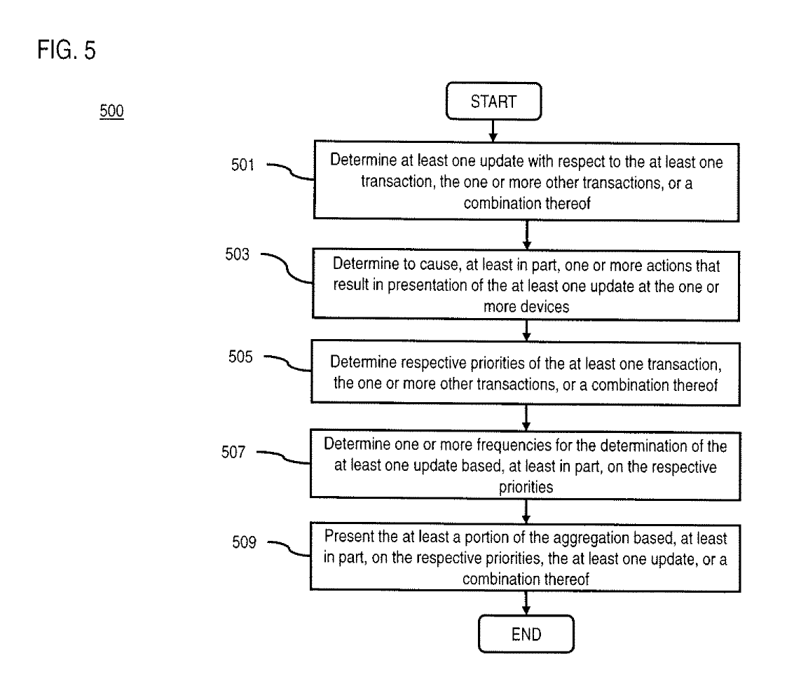

FIG. 5 is a flowchart of a process for providing status information on service requests, according to an embodiment. In one embodiment, the control logic 205 of the service aggregator 117 performs the process 500 and is implemented in, for instance, a chip set including a processor and a memory as shown FIG. 10. In certain embodiments, the execution module 305 of a UE 101 may perform one or more steps of the process performed by the control logic 205. As such, the control logic 205 and/or execution module 305 can provide means for accomplishing various parts of the process 500 as well as means for accomplishing other processes in conjunction with other components. At step 501, the control logic 205 determines at least one update with respect to the at least one transaction, the one or more other transactions, or a combination thereof. In one embodiment, updated information is determined on at least one transaction, for example, an estimated time of service, further information required from the user, and the like.

At step 503, the control logic 205 determines to cause, at least in part, one or more actions that result in presentation of the at least one update at the one or more devices. In an embodiment, the user 103 and/or the UE 101 requests update information on one or more service request records. For example, the user wishes to know status of a request for flower delivery to a client. In another embodiment, the service platform 113 and/or the service provider 109 (e.g., a concierge agent) determines that there are one or more updates on the one or more service request records and causes the one or more updates to be presented at the service aggregator 117. For example, the service provider 109 has update information on one or more records to indicate estimated service delivery time, service vendor and the like.

At step 505, the control logic 205 determines respective priorities of the at least one transaction, the one or more other transactions, or a combination thereof. In one embodiment, the respective priorities of the one or more transactions are determined by the user and are so presented by the service aggregator. For example, the user determines that a service request for transportation to an airport has higher priority than one or more other requests. In another embodiment, the service platform 113 and/or the service provider 109 determine the priorities of the one or more service requests. For example, a request for hotel accommodations for the user arriving at user destination is determined with higher priority than a request for dining accommodations on the following day. In another embodiment, the user can further re-determine priority of the one or more requests determined by the service platform 113 and/or the service provider 109. For example, the user can prioritize one or more service requests higher than prioritization determined by the service provider.

At step 507, the control logic 205 determines one or more frequencies for the determination of the at least one update based, at least in part, on the respective priorities. In one embodiment, frequency of updates on the one or more service requests is based, at least in part, on the priority of the one or more service requests. For example, status of a service request with a higher priority will be updated more frequently when compared to other service requests with lower priority. In another embodiment, the user and/or the user device may request updates based on one or more criteria as determined by the user regardless of service request priority.

At step 509, the control logic 205 determines to present at least a portion of the aggregation based, at least in part, on the respective priorities, the at least one update, or a combination thereof. In one embodiment, the one or more updates can be aggregated and presented to the user based on one or more criteria determined by the user, user device, service platform 113 and/or service provider 109. In one scenario, the service request records are presented based, at least in part, on priority level and available updates. In another embodiment, the service request records are presented with available updates first. In another embodiment, the service request records are presented based on a list of request selected by the user.

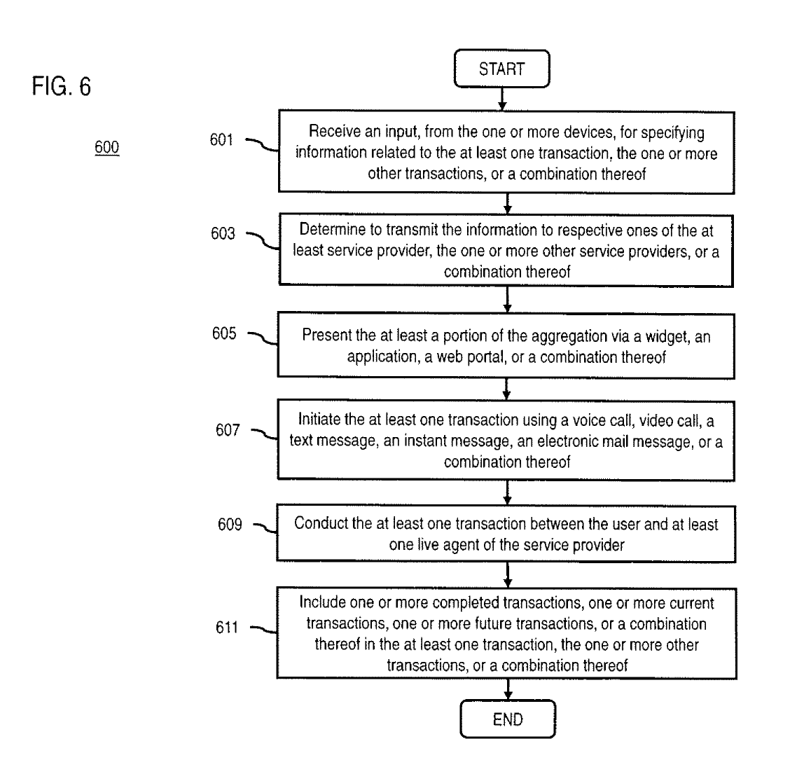

FIG. 6 is a flowchart of a process for generating service requests, according to an embodiment. In one embodiment, the control logic 205 of the service aggregator 117 performs the process 600 and is implemented in, for instance, a chip set including a processor and a memory as shown FIG. 10. In certain embodiments, the execution module 305 of a UE 101 may perform one or more steps of the process performed by the control logic 205. As such, the control logic 205 and/or execution module 305 can provide means for accomplishing various parts of the process 600 as well as means for accomplishing other processes in conjunction with other components.

At step 601, receive an input, from the one or more devices, for specifying information related to the at least one transaction, the one or more other transactions, or a combination thereof. In one embodiment, the user 103 utilizes the UE 101 to provide information on the one or more service requests.

At step 603, the service provider determines to transmit the information to respective ones of the at least service provider, the one or more other service providers, or a combination thereof. In one embodiment, the user service requests are assigned to one or more service providers 109 and/or service platform 113 based, at least in part, on user criteria (e.g., user language, user gender, user age, user priority level, etc.), service request type (e.g., hotel, travel, dining, etc.), user device (e.g., phone, internet, in person, etc.), service request priority (e.g., urgent, next day, etc.) user and/or user device location (e.g., city, country, region, etc.).

At step 605, at least a portion of the aggregation is presented via a widget, an application, a web portal, or a combination thereof. In one embodiment, the user service requests are listed and/or aggregated for presentation to the user and/or user device. For example, the user service requests can be presented and/or available to the user via a user device, an internet portal and the like.

At step 607, the at least one transaction is initiated by using a voice call, video call, a text message, an instant message, an electronic mail message, or a combination thereof. In one embodiment, the user utilizes one or more methods and/or user devices to generate the one or more service requests, for example, the user can utilize a phone (e.g., a mobile device, a land line phone) and/or a computer for a voice call, a video call, an IM chat session, an SMS, an MMS, an email and/or the like.

At step 609, the at least one transaction is conducted between the user and at least one live agent of the service provider. In one embodiment, the user communicates with a service provider 109 person. For example, the user can have one or more service providers 109 (e.g., human agents) pre-assigned to the user for providing one or more user services based on, at least in part, a membership, upon an account activation, a user device, a geographical location, an organization and the like.

At step 611, one or more completed transactions, one or more current transactions, one or more future transactions, or a combination thereof are included in the presentation of at least one transaction, the one or more other transactions, or a combination thereof. In one embodiment, the service aggregator 117 presents a list of one or more user service requests. For example, the user can view service request history for reference and/or to provide to the service provider 109 as for further reference/information. Further, the user can view one or more pending service requests for further prioritization, modification, and the like.

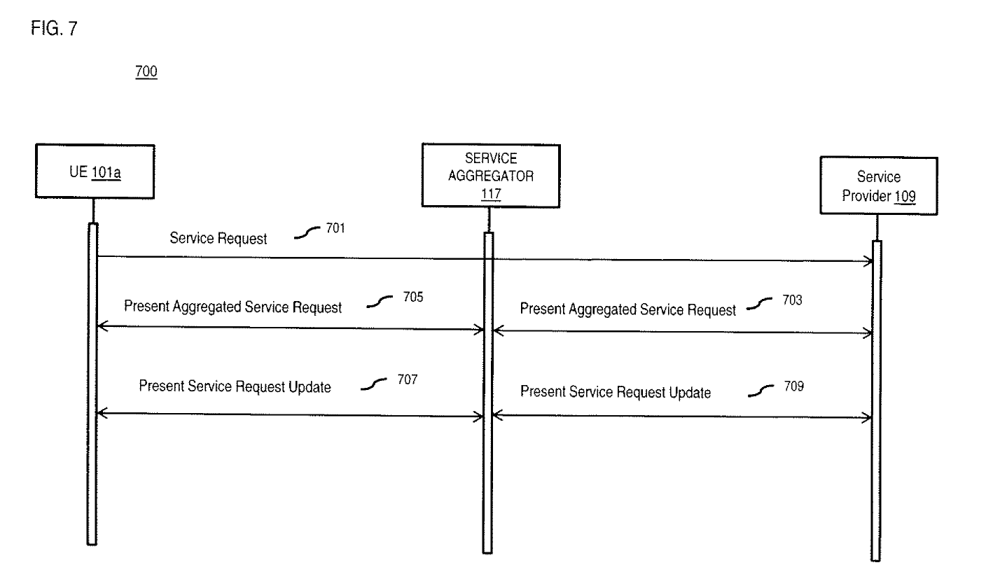

FIG. 7 is a time sequence diagram that illustrates a sequence of messages and processes for generating and managing service requests, according to an embodiment. A network process on the network is represented by a thin vertical box. A message passed from one process to another is represented by horizontal arrows. A step performed by a process is indicated by a box or looping arrow overlapping the process at a time sequence indicated by the vertical position of the box or looping arrow. The processes represented in FIG. 7 are the UE 101a corresponding to a user, the service aggregator 117, and the service provider 109.

In the process 701, the user 103 via UE 101a generates one or more service requests for, at least, service provider 109. Once the service provider 109 receives the one or more service requests, service provider 109 causes, at least in part, creation of one or more service requests at the service platform 113 and/or assignment of the one or more service requests to one or more service vendors 121. At 703, the service provider 109 and/or the service platform 113 cause, at least in part, an aggregated list of the service requests at the service aggregator 117. At 705, the aggregated one or more service requests are available to the user 103 and/or UE 101a. For example, the user can view and/or manage the one or more service requests. At 707, the user 103 and/or the UE 101 can provide one or more updates on the one or more service requests to, at least, the service provider 109, service platform 113 and/or the service vendor 121. For example, the user can provide the update via one or more communication methods, such as in person, by phone, via SMS, MMS, email, and the like. Furthermore at 709, the service provider 109 can cause, at least in part, to present one or more updates on the one or more user service requests. For example, the service provider 109 can request for more information from the user, can present one or more updated on the one or more user service requests and/or the like.

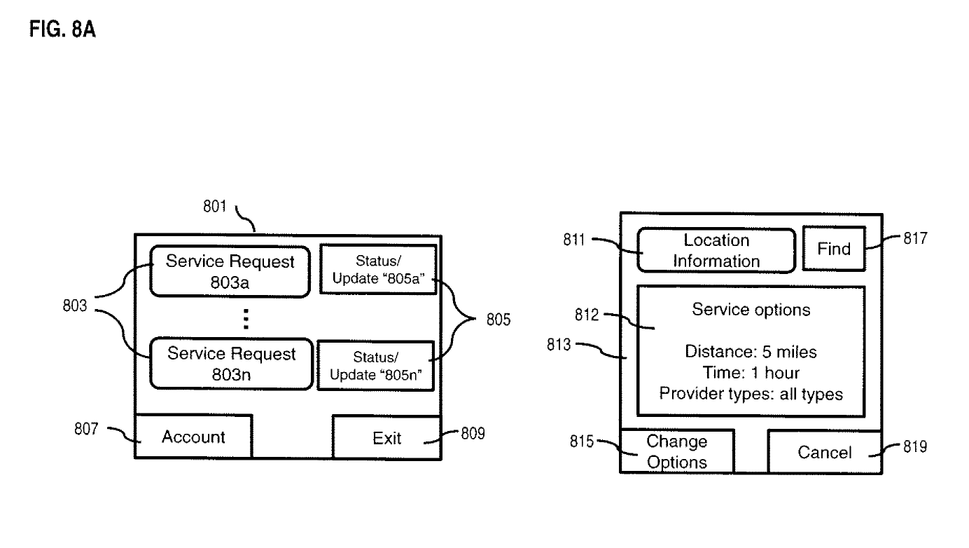

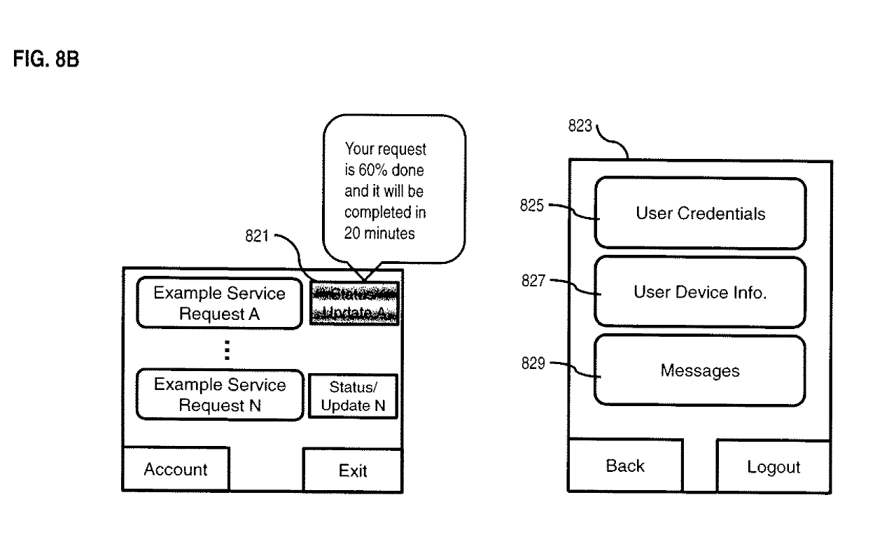

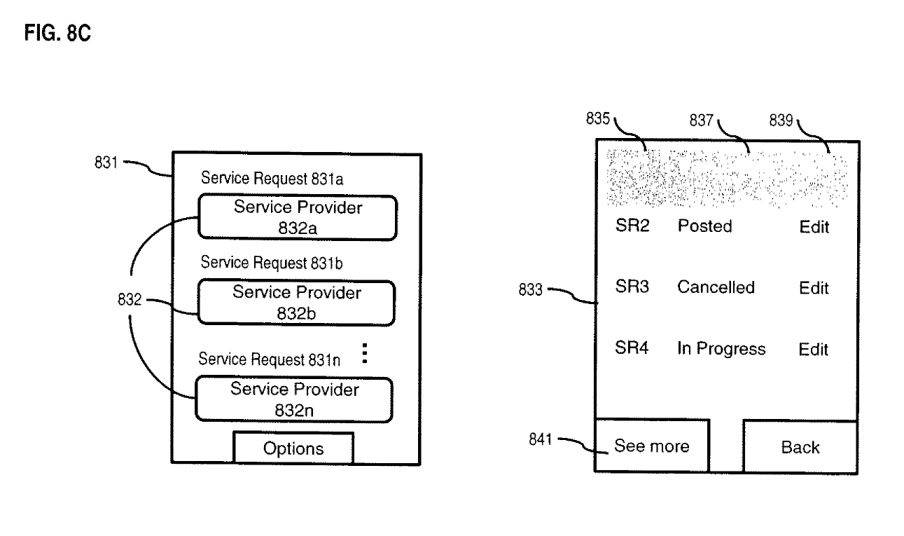

FIGS. 8A-8C are diagrams of user interfaces (UI) utilized in the processes of FIGS. 4-7, according to various embodiments. It is noted that the depicted UI features are examples and that the UIs can be rendered in various forms, shapes, preferences and the like.

At FIG. 8A, user interface 801 includes an example interface utilized to present one or more service requests 803a-803n. In one embodiment, the user can view the one or more service requests in the list in any order determined by the user. For example, the user can view the one or more requests based on priority, user interest, status, actions required by the user, and the like. Further, at 805 one or more status and/or update information, 805a-805-n, are presented on the one or more service requests. In one embodiment, the user can select the one or more service requests and/or the status information to view the one or more status information. For example, the user can select (e.g., by clicking, hovering over with a pointer, highlighting, etc.) the one or more status information in order to view details of the status information. At user interface 801 user of UE 101 can manage one or more user accounts, via 807, for example, at service aggregator 117, service agent 109, at UE 101, at a social network site, and/or the like. In one embodiment, the user and/or the user device can substantially directly and/or via a single-sign-on mechanism access one or more accounts for example, a personal account, a shared account, a social network account, a company account or a combination thereof. Moreover, at user interface 809 a user can exit the user interface.

Further, user interface 813 includes an example interface to provide additional information, for example, location information. At 812, a user can specify one or more service request options, for example, a distance from the user, estimated time of arrival at a destination, indicate type of service required and the like. At 815, the user may change one or more options and at 817 the user may execute the request. At 819, the user can cancel all or portion of one or more service requests via the user interface 812.

At FIG. 8B, examples of various user interfaces are utilized to indicate information on one or more service requests. In one embodiment, the status information can indicate progress on the one or more service requests. For example, indicator 821 indicates progress of the service request as completed at 60% and an estimated time of completion. The progress indicators can be implemented by using a percentage number, pie-chart, progress bar, and the like. Further, a color scheme may be used to indicate status of one or more service requests, for example, red, yellow, green, blue, etc. For example, red could indicate progress has stopped and further action by the user is required; yellow could indicate further action by the service provider 109 is required; green could indicate the service request has been completed; blue could indicate the service request is in progress. Furthermore, in order for a user to have substantially same user experience when accessing a user service (e.g., a concierge service), one or more user devices can implement substantially same user interface. For example, a user can request one or more services utilizing a different device than usually used by the user (e.g., a computer rather than the user's mobile phone). In one embodiment, a user can use one or more different devices to access the user service and for doing so, the user can provide the user's account/credentials via indicator 825 at user interface 823. At indicator 827, the user can provide the user's device information and at 829 the user can check for any messages from one or more service providers. In another embodiment, the user can access substantially same user service via a web portal, via SMS, MMS, email and the like.

At FIG. 8C, examples of various user interfaces are utilized to indicate information on one or more service requests. User interface 831 is utilized to indicate one or more user service requests and one or more service providers assigned to process the one or more service request. In one embodiment, each user service request is assigned to a service provider. For example, one or more user service requests, 831a-831n, are assigned to one or more service providers 832a-832n. However, each of the one or more user service requests can be assigned to one or more service providers. In another embodiment, one or more user service requests can be assigned to one service provider. For example, one or more user service requests are assigned to a service provider that can fulfill the requests based, at least in part, on the location of the: user, the one or more service requests, the service provider, the service delivery and the like.

In another embodiment, user interface 833 presents a list of one or more user service requests. Indicator 835 lists the one or more (e.g., past and/or pending), for example, service requests SR1-SR4. Indicator 837 presents status of the one or more service requests (e.g., completed, posted, cancelled, in progress, etc.). Indicator 839 presents one or more actions available to the user, for example, ability to edit the one or more service requests (e.g., cancel, re-prioritize, modify, etc.). Further, indicator 841 can present one or more additional service requests, for example, one or more past and/or pending service requests.

With the above example approaches, a system to generate and/or manage one or more service requests is provided. In this manner, users generate one or more requests for one or more services and status update on the one or more service requests can be substantially automated and provided in real time. The system allows for the real time access for generating and/or managing one or more service requests between users and service providers. The real time access allows for the users to obtain status update on or more service requests from one or more service providers.

The processes described herein for generating and/or managing one or more service requests may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

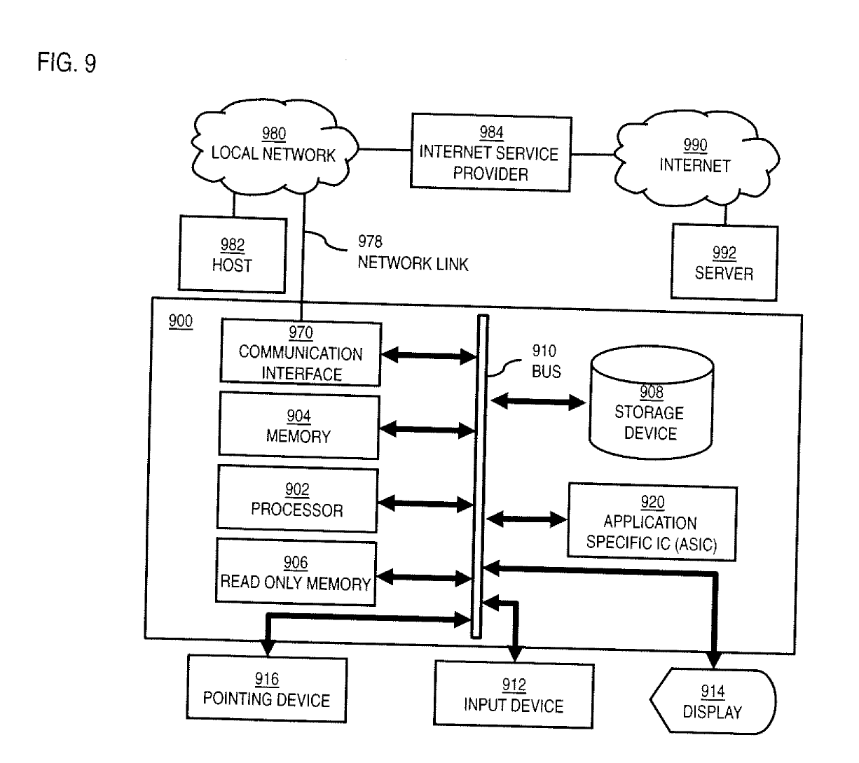

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to share and manage resource availability information as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of generating and/or managing one or more service requests.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to generating and/or managing one or more service requests. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for sharing and managing resource availability information. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for generating and/or managing one or more service requests, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 107 for the UE 101, service platform 113, service aggregator 117, and services vendors 121.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to generate and/or manage one or more service requests as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps for generating and/or managing one or more service requests.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to share and manage resource availability information. The memory 1005 also stores the data associated with or generated by the execution of the inventive steps.

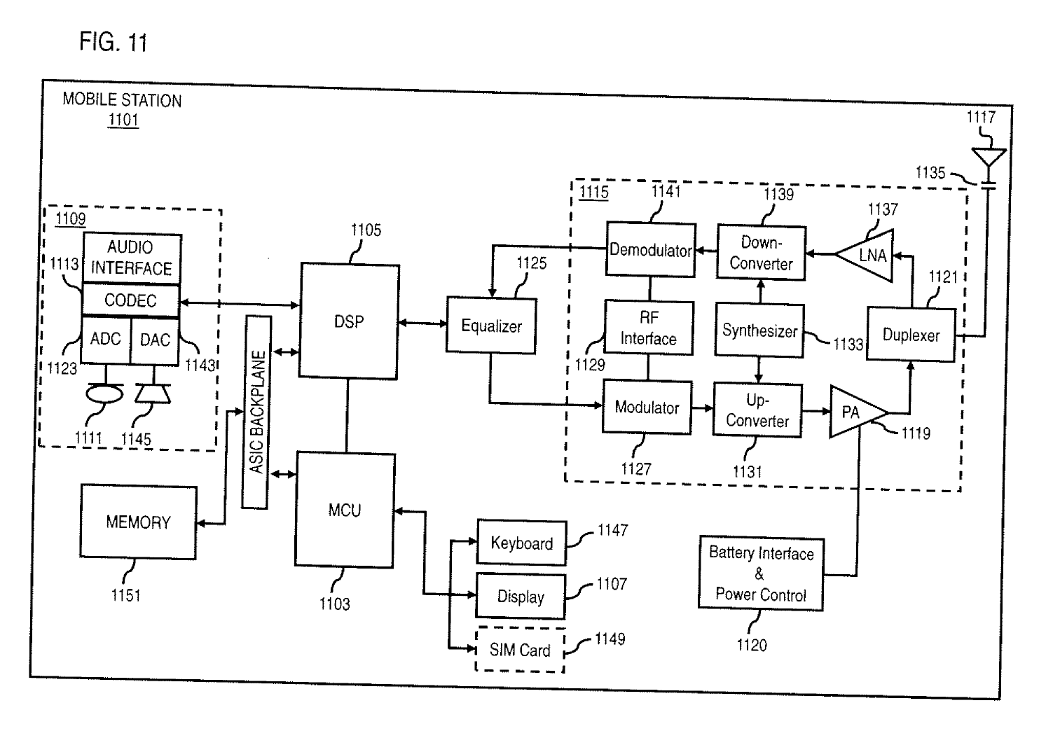

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of generating and/or managing one or more service requests. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of sharing and managing resource availability information. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to share and manage resource availability information. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing: (1) data and/or (2) information and/or (3) at least one signal; the (1) data and/or (2) information and/or (3) at least one signal based at least in part on the following:
at least one record of at least one transaction between a user and at least one service provider;
at least one aggregation of the at least one record with one or more other records, the one or more other records relating to one or more other transactions between the user and the at least one service provider, one or more other service providers, or a combination thereof; and
at least one determination to cause, at least in part, one or more actions for resulting in presentation of at least a portion of the aggregation at one or more devices associated with the user.

2. A method of claim 1, wherein the (1) data and/or (2) information and/or (3) at least one signal are further based at least in part on the following:
at least one update with respect to the at least one transaction, the one or more other transactions, or a combination thereof; and
at least one determination to cause, at least in part, one or more actions for resulting in presentation of the at least one update at the one or more devices.

3. A method of claim 2, wherein the (1) data and/or (2) information and/or (3) at least one signal are further based at least in part on the following:
respective priorities of the at least one transaction, the one or more other transactions, or a combination thereof; and
one or more frequencies for the determination of the at least one update based, at least in part, on the respective priorities.

4. A method of claim 3, wherein the presentation of the at least a portion of the aggregation is based, at least in part, on the respective priorities, the at least one update, or a combination thereof.

5. A method of claim 1, wherein the (1) data and/or (2) information and/or (3) at least one signal are further based at least in part on the following:
an input, from the one or more devices, for specifying information related to the at least one transaction, the one or more other transactions, or a combination thereof; and
a transmission of the information to respective ones of the at least service provider, the one or more other service providers, or a combination thereof.

6. A method of claim 1, wherein the presentation of the at least a portion of the aggregation is via a widget, an application, a web portal, or a combination thereof.

7. A method of claim 1, wherein the at least one transaction is initiated using a voice call, video call, a text message, an instant message, an electronic mail message, or a combination thereof.

8. A method of claim 1, wherein the at least one transaction is between the user and at least one live agent of the service provider.

9. A method of claim 1, wherein the at least one transaction, the one or more other transactions, or a combination thereof include one or more completed transactions, one or more current transactions, one or more future transactions, or a combination thereof.

10. An apparatus comprising:
at least one processor; and
at least one memory including computer program code for one or more programs,
the at least one memory and the computer program code configured to, with the at least one processor, cause the apparatus to perform at least the following,
process at least one record of at least one transaction between a user and at least one service provider;
process at least one aggregation of the at least one record with one or more other records, the one or more other records relating to one or more other transactions between the user and the at least one service provider, one or more other service providers, or a combination thereof; and
determine to cause, at least in part, one or more actions for resulting in presentation of at least a portion of the aggregation at one or more devices associated with the user.

11. An apparatus of claim 10, wherein the apparatus is further caused, at least in part, to:
process at least one determination of an update with respect to the at least one transaction, the one or more other transactions, or a combination thereof; and
determine to cause, at least in part, one or more actions for resulting in presentation of the at least one update at the one or more devices.

12. An apparatus of claim 11, wherein the apparatus is further caused, at least in part, to:
process respective priorities of the at least one transaction, the one or more other transactions, or a combination thereof; and
process one or more frequencies for the determination of the at least one update based, at least in part, on the respective priorities.

13. An apparatus of claim 12, wherein the presentation of the at least a portion of the aggregation is based, at least in part, on the respective priorities, the at least one update, or a combination thereof.

14. An apparatus of claim 10, wherein the apparatus is further caused, at least in part, to:
process an input, from the one or more devices, for specifying information related to the at least one transaction, the one or more other transactions, or a combination thereof and
determine to transmit the information to respective ones of the at least service provider, the one or more other service providers, or a combination thereof.

15. An apparatus of claim 10, wherein the presentation of the at least a portion of the aggregation is via a widget, an application, a web portal, or a combination thereof.

16. An apparatus of claim 10, wherein the at least one transaction is initiated using a voice call, video call, a text message, an instant message, an electronic mail message, or a combination thereof.

17. An apparatus of claim 10, wherein the at least one transaction is between the user and at least one live agent of the service provider.

18. An apparatus of claim 10, wherein the at least one transaction, the one or more other transactions, or a combination thereof include one or more completed transactions, one or more current transactions, one or more future transactions, or a combination thereof.

19. A computer-readable storage medium carrying one or more sequences of one or more instructions which, when executed by one or more processors, cause an apparatus to at least perform the following:
determining at least one record of at least one transaction between a user and at least one service provider;
determining an aggregation of the at least one record with one or more other records, the one or more other records relating to one or more other transactions between the user and the at least one service provider, one or more other service providers, or a combination thereof; and
determining to cause, at least in part, one or more actions for resulting in presentation of at least a portion of the aggregation at one or more devices associated with the user.

20. A computer-readable storage medium of claim 19, wherein the apparatus is caused to further perform:
determining at least one update with respect to the at least one transaction, the one or more other transactions, or a combination thereof; and
determining to cause, at least in part, one or more actions for resulting in presentation of the at least one update at the one or more devices.

21.-45. (canceled)
